(19) United States
(12) Patent Application Publication
(10) Pub. No.: US 2022/0123398 A1
(43) Pub. Date: Apr. 21, 2022

(54) BATTERY BACKUP UNIT CONTAINER

(71) Applicant: Robby KINSALA, Waxahachie, TX (US)

(72) Inventor: Robby KINSALA, Waxahachie, TX (US)

(21) Appl. No.: 17/143,566

(22) Filed: Jan. 7, 2021

Related U.S. Application Data
(60) Provisional application No. 63/093,998, filed on Oct. 20, 2020.

(51) Int. Cl. H01M 50/202; H01M 10/48; H01M 50/102

(52) U.S. Cl. CPC H01M 50/202; H01M 2200/00; H01M 50/102; H01M 10/482

(57) ABSTRACT

A battery backup unit container comprises a top, front, rear, sides and a base, a shuttle assembly, and one or more vertical dividers. The shuttle assembly and one or more vertical dividers are positioned between the top, front, rear, and sides, when the container is in a closed condition. The shuttle assembly comprises bays, each of which is adapted to a battery backup unit. One or more of the top, front, rear, or sides are directly or indirectly hingedly attached to the base such that the container can be selectively placed in the closed condition or an open condition. At least one of the one or more vertical dividers is electrically conductive. The exterior of the container is electrically conductive. The container is grounded such that static electricity within the container can be discharged. In other embodiments, there are two shuttle assemblies, and the vertical dividers comprise foam.

This application claims the benefit of provisional application No. 63/093,998 filed Oct. 20, 2020, the contents of which are hereby incorporated by reference.

### BACKGROUND OF THE INVENTION

### 1. Field of the Invention

The present invention relates generally to a container and specifically to a battery backup unit storage container adapted to store and transport batteries.

### 2. Description of the Prior Art

Battery Back Up Units (BBU) are used in data centers, server environments, and other facilities to permit power to be maintained in the event of a power outage. New BBUs received by the data center are repackaged. Old BBUs are stored. However, the manual repetition of these activities is prone to injuries (sprains and strains), incurs costs, and produces wastage. Additionally, stored batteries sometimes experience a phenomenon known as “thermal runaway”. Thermal runaway can occur when the stored chemical energy of the battery is converted to thermal energy. A cascading failure can result, for example, from a single cell short circuit that leads to the failure of a large pack of cells. Such failure can result in a fire causing much damage to life, person, and property. Many conventional methods of storing BBU's are ineffective for containing thermal runaway.

What is needed is battery backup unit storage container that allows for easy and safe storage and movement of batteries and also reduces the potential for thermal runaway of the BBU's stored within the case.

### SUMMARY OF THE INVENTION

The battery backup unit storage container (sometimes referred to herein as “container”) of the preferred embodiment allows for easy and safe storage and movement of batteries and also contains thermal runaway. The container generally comprises a rectangular configuration comprising a top, front, rear, sides, and a base. Coupled to the base are skids. The front and rear are each hingedly attached to the base via hinges. Nested within the battery backup unit storage container are respective shuttle assemblies, vertical dividers comprising windowpane dividers, intermediate dividers, and central dividers. In the preferred embodiments, windowpane dividers, intermediate dividers, and central dividers comprise foam. In preferred embodiments, an exterior of the battery backup unit storage container comprises aluminum.

Although in the preferred embodiment, the battery backup unit storage container comprises dual shuttle assemblies, dual windowpane dividers, dual intermediate dividers, and dual central dividers, the container need not have such configuration. Rather, the container can have a greater or fewer number of shuttle assemblies and vertical dividers. For example, in other embodiments, the container comprises a single shuttle assembly, single windowpane divider, a single intermediate divider, and a single central divider. In such embodiment, for example, the container front may be hingedly attached, as described above, and the rear may be non-hingedly attached.

The top of the preferred embodiment comprises a plurality of skid captures positioned adjacent to corners of the top. Each corner of the preferred embodiment comprises two skid captures arranged orthogonally to one another such that a right angle is formed. Each skid capture extends above the top such that that each paired skep capture is adapted to retain a portion of a skid from a separate battery backup unit storage container. The top further comprises a downward extending perimeter edge adapted to align generally flush with sides and front and rear (when front and rear are in a secured positioned). An underside of top may comprise one or more lateral support members arranged, as will be discussed below, similarly to the support members of base. A space defined by downward extending perimeter edge, the underside of top, and support members, in preferred embodiments, comprises foam board. In the preferred embodiment, this foam board is electrostatic discharge (ESD) closed cell foam board. The top of the preferred embodiment is formed from aluminum. Although the top of the preferred embodiment, as well as other components of the container are formed from aluminum, other suitable materials may be used. Preferably, such other suitable materials are relatively good conductors to permit static electricity to be readily discharged.

The front and rear of the preferred embodiment each comprise edge frames that, along with respective undersides of front and rear, define respective spaces adapted to receive foam board. The foam board of front and rear of preferred embodiments is closed cell ESD foam. The front and rear of preferred embodiments are formed from aluminum. The front and rear optionally comprise document holders adapted to retain certain documents pertaining to, for example, certain contents of the container or shipping information. In preferred embodiments, such document holders are transparent. In certain embodiments, the front and rear comprise a hinge protector. This hinge protector is positioned such that when the front or rear is moved to the open position, the hinge protector contacts a lower portion of the hinge. In the preferred embodiment, the hinge protector is formed from high-density polyethylene (HDPE) and is recyclable. However, other suitable materials may be used.

In the preferred embodiment, the container comprises a plurality of latching assemblies, each comprising a catch, and a latch comprising a clasp. Respective catches are mounted on the edge frames of the front and rear and are adapted to receive respective clasps of the latches mounted on the sides. In the preferred embodiment, there are a total of eight latching assemblies. As the front and rear are hingedly mounted to the base via hinges, the front and rear are adapted to be moved to an open position by decoupling clasps from catches. In the preferred embodiment, the latch is recessed within side. In addition to the latches, each side of the preferred embodiment comprises one or more tie rings. These tie rings are pivotally coupled to a recessed tie holder.

The respective shuttle assemblies each comprise a shuttle top, shuttle bottom, shuttle sides, shuttle lateral members, and shuttle vertical members. The shuttle top, shuttle bottom, and shuttle sides each comprise a plurality of grooves that permit the shuttle assembly to be assembled with close tolerances. Thus, in the preferred embodiment, upper and lower portions of the vertical portions nest within corresponding grooves of the shuttle top and shuttle bottom. Similarly, outside edges of the lateral portions nest within corresponding grooves of the shuttle sides. The vertical members comprise partial slots adapted to receive the lateral members. The lateral members also comprise partial slots which permit front portions of lateral members to be positioned generally flush with front portions of vertical members. When assembled, a plurality of bays are defined. In the preferred embodiment, each shuttle assembly comprises thirty bays, each bay being adapted to receive a battery backup unit (BBU). Each of the vertical members and sides further comprise a through opening adapted to receive a movable detent of the battery backup unit.

When assembled, the container comprises the windowpane dividers, the intermediate dividers, and the central dividers. The windowpane dividers of the preferred embodiment comprise perimeter cutouts that are adapted to permit the windowpane dividers to be positioned adjacent to support members of the top and base. The windowpane dividers further comprise central cutouts aligning with the bays. With this configuration, portions of the battery backup unit can, for example, extend into the respective central cutout. In the preferred embodiment, the windowpane dividers are formed from closed cell ESD foam. Thus, the windowpane dividers are electrically conductive and is in electrical contact with the aluminum exterior of the container such that static electricity can be discharged.

The intermediate dividers also comprise perimeter cutouts which are adapted to permit the intermediate dividers to be positioned adjacent to support members of the top and base. The intermediate dividers of the preferred embodiment do not comprise central cutouts aligning with the bays. Thus, the intermediate dividers serve as a barrier between the respective windowpane dividers and respective central divider. In the preferred embodiment, the intermediate dividers are formed from closed cell ESD foam.

The central dividers also comprise perimeter cutouts which are adapted to permit the central dividers to be positioned adjacent to support members of the top and base. The central dividers of the preferred embodiment do not comprise central cutouts aligning with the bays. In the preferred embodiment, the central dividers are formed from closed cell polyethylene that is resilient in nature with favorable recovery characteristics that provide cushioning protection against repeated impacts. In certain embodiments, the central dividers comprise anti-static and formulations. In some embodiments, the central dividers are electrically conductive. In certain embodiments, the container is grounded to reduce risk from ESD. The central dividers are much thicker than the windowpane dividers and the intermediate dividers.

In the preferred embodiment, the shuttle assembly is constructed from HDPE. Exterior portions are constructed from aluminum. The total depth of the container is approximately 54 inches. The total width of the container is approximately 44 inches. The approximate height of the container is approximately 27 inches. In the preferred embodiment, the central dividers are each five inches thick while the windowpane dividers and the intermediate dividers measure ¾ inch and one inch, respectively. These dimensions, as other dimensions in this disclosure can vary without departing from the scope and spirit of the invention.

In the preferred embodiment, the battery backup unit storage container is adapted to permit BBU separation for secure transportation. In certain embodiments, the container shuttle assembly is removable and reconfigurable. Thus, the shuttle assembly can comprise, for example, a different number of bays. The hinged front and rear permit easy loading/unloading. In those embodiments, in which the container has a stackable design, storage space is optimized.

### BRIEF DESCRIPTION OF THE DRAWINGS

FIG. 1 is a top, right, and front isometric view of the battery backup unit storage container, in accordance with a preferred embodiment.

FIG. 2 is a front elevational view of the battery backup unit storage container of FIG. 1.

FIG. 3 is a right elevational view of the battery backup unit storage container of FIG. 1.

FIG. 4 is a sectional view taken along the line IV-IV of FIG. 3.

FIG. 5 is an exploded view of the battery backup unit storage container of FIG. 1.

FIG. 6 is a top, right, and front isometric view of the shuttle portion of the battery backup unit storage container of FIG. 1.

FIG. 7 is an exploded view of the shuttle of FIG. 6.

FIG. 8 is a partially exploded view of the battery backup unit storage container of FIG. 1.

FIG. 9 is a front elevation view of the central divider of the battery backup unit storage container of FIG. 1.

FIG. 10 is a top plan view of the central divider of FIG. 9.

FIG. 11 is a top, right, and front isometric view of the windowpane divider of the battery backup unit storage container of FIG. 1.

FIG. 12 is a front elevation view of the intermediate divider of the battery backup unit storage container of FIG. 1.

FIG. 13 is a top plan view of the intermediate divider of FIG. 12.

FIG. 14 depicts the battery backup unit storage container stacked upon another battery backup unit storage container.

FIG. 15 depicts the battery backup unit storage container in a stacked configuration with the front in an open position, in accordance with a preferred embodiment.

FIG. 16 depicts batter backup units stored within the shuttle, in accordance with a preferred embodiment.

FIG. 17 is a closeup of the circled portion of FIG. 16.

### DESCRIPTION OF THE PREFERRED EMBODIMENT

Referring to the figures, there is shown the battery backup unit storage container 12 in accordance with preferred embodiments. As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation. The detailed description illustrates by way of example, not by way of limitation, the principles of the invention. This description will clearly enable one skilled in the art to make and use the invention, and describes several embodiments, adaptations, variations, alternatives, and uses of the invention, including what is presently believed to be the best mode of carrying out the invention.

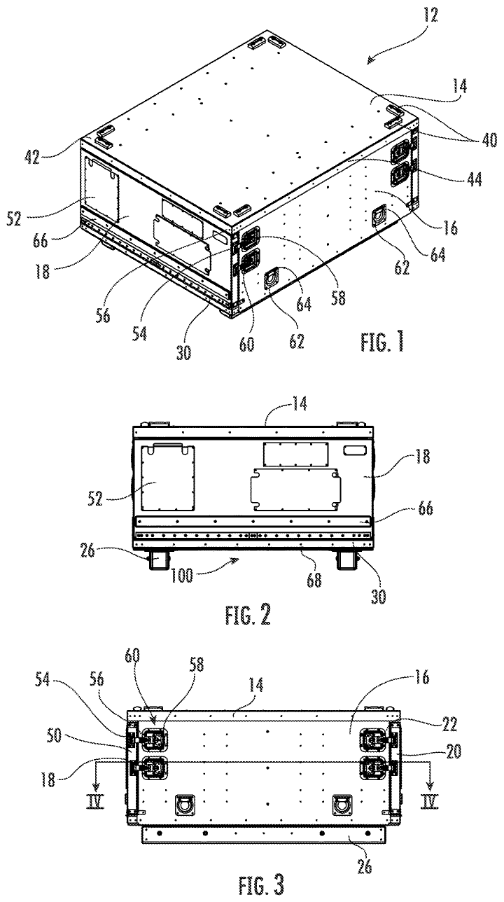

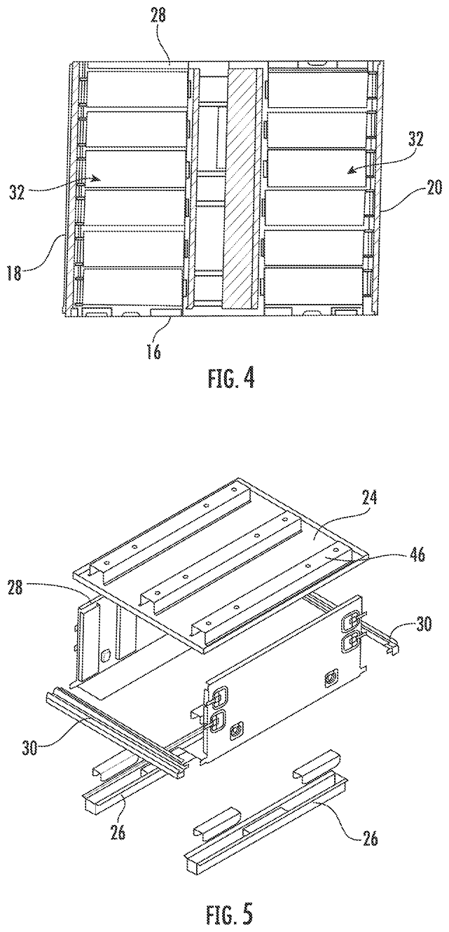

Referring to FIGS. 1-8, the battery backup unit storage container 12 (sometimes referred to herein as “container” 12) of the preferred embodiment generally comprises a rectangular configuration comprising a top 14, front 18, rear 20, sides 16, 28 and a base 24. Coupled to the base 24 are skids 26, 26. The skids 26, 26 are structured and arranged to permit the container 12 to be raised with a forked lifting device such as a forklift or a pallet jack. In preferred embodiments, the skids 26, 26 are elongated and span parallel with sides 16, 28. This structure permits a pair of forks of a pallet jack or forklift to be positioned with a space 100 (FIG. 2) beneath the base 24 and between the two skids 26, 26. In other embodiments, the skids 26, 26 are positioned parallel to the front 18 and rear 20. The skids 26, 26 of preferred embodiments are formed from electroconductive material such as metal.

The front 18 and rear 20 are each hingedly attached to the base 24 via hinges 30, 30. Nested within the battery backup unit storage container 12 are respective shuttle assemblies 32, 32, vertical dividers 34, 36, 38 comprising windowpane dividers 34,34, intermediate dividers 36, 36, and central dividers 38, 38.

In preferred embodiments, an exterior of the battery backup unit storage container 12 comprises aluminum. This aluminum exterior serves as an efficient heat sink to allow heat to spread over a large surface area and cool by convection from ambient air flow away from the internal components and BBU's 90 housed within the container 12. Therefore, for example, an external heat source up to and including flames fueled by accelerants is unlikely to cause a failure leading to thermal runaway of the BBU's 90.

The aluminum exterior of the preferred embodiment is preferably puncture resistant such that the container 12 will remain intact during typical shipping and/or storage operations. The cells comprising the BBUs 90 are preferably comprised of very stable chemistry and the container 12 together with the BBU 90 design help prevent thermal runaway propagation to adjacent BBU's 90 packed within the container 12 and thereby cause no further risk or hazard to personnel, equipment, or facilities.

Although in the preferred embodiment, the battery backup unit storage container 12 comprises dual shuttle assemblies 32, 32, dual windowpane dividers 34, 34, dual intermediate dividers 36, 36, and dual central dividers 38, 38, the container 12 need not have such configuration. Rather, the container 12 can have a greater or lesser number of shuttle assemblies 32 and vertical dividers 34, 36, 38. For example, in other embodiments, the container 12 comprises a single shuttle assembly 32, a single windowpane divider 34, a single intermediate divider 36, and a single central divider 38. In such embodiment, for example, the container front 18 may be hingedly attached, as described above, and the rear 20 may be non-hingedly attached.

The top 14 of the preferred embodiment comprises a plurality of skid captures 40 positioned adjacent to corners 42 of the top 14. Each corner 42 of the preferred embodiment comprises two skid captures 40 arranged orthogonally to one another such that a right angle is formed. Each skid capture 40 extends above the top such that that each paired skep capture is adapted to retain a portion of a skid 26 from a separate battery backup unit storage container 13 as shown, for example, in FIG. 14. The top 14 further comprises a downward extending perimeter edge 44 adapted to align generally flush with sides 16, 28 and front 18 and rear 20 (when front 18 and rear 20 are in a secured positioned, depicted, for example, in FIGS. 1-3). An underside of top 14 (not shown) may comprise one or more lateral support members 46 arranged, as will be discussed below, similarly to the support members 46 of base 24. A space defined by downward extending perimeter edge 44, the underside of top 14, and support members 46, in preferred embodiments, comprises foam board 48. In the preferred embodiment, this foam board is electrostatic discharge (ESD) closed cell foam board. The top 14 of the preferred embodiment is formed from aluminum. Although the top 14 of the preferred embodiment, as well as other components of the container 12 are formed from aluminum, other suitable materials may be used. Preferably, such other suitable materials are relatively good conductors to permit static electricity to be readily discharged.

The front 18 and rear 20 of the preferred embodiment each comprise edge frames 50 that, along with respective undersides of front 18 and rear 20, define respective spaces adapted to receive foam board 48. The foam board 48 of front 18 and rear 20 of preferred embodiments is closed cell ESD foam. The front 18 and rear 20 of preferred embodiments are formed from aluminum. As shown for example, in FIGS. 1 and 2, the front 18 and rear 20 optionally comprise document holders 52 adapted to retain certain documents pertaining to, for example, certain contents of the container 12 or shipping information. In preferred embodiments, such document holders 52 are transparent. In certain embodiments, the front 18 and rear 20 comprise a hinge protector 66. This hinge protector 66 is positioned such that when the front 18 or rear 20 is moved to the open position (such that the container 12 is in an open condition), the hinge protector 66 contacts a lower portion 68 of the hinge 30. In the preferred embodiment, the hinge protector 66 is formed from high-density polyethylene (HDPE) and is recyclable. However, other suitable materials may be used.

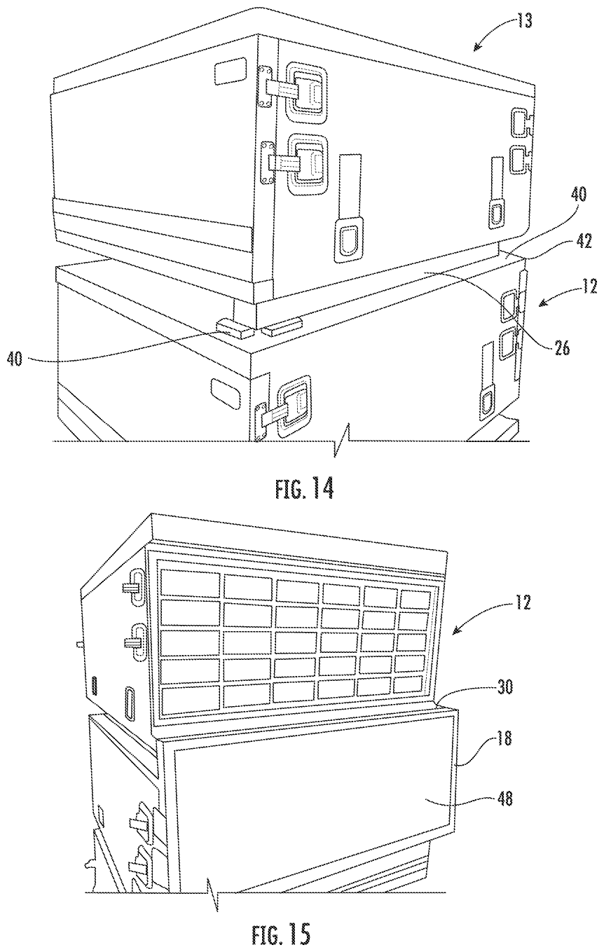

In the preferred embodiment, the container 12 comprises a plurality of latching assemblies 60, each comprising a catch 54, and a latch 58 comprising a clasp 56. Respective catches 54 are mounted on the edge frames 50 of the front 18 and rear 20 and are adapted to receive respective clasps 56 of the latches 58 mounted on the sides 16, 28. In the preferred embodiment, there are a total of eight latching assemblies 60. As the front 18 and rear 20 are hingedly mounted to the base via hinges 30, the front 18 and rear 20 are adapted to be moved to an open position as shown for example, in FIG. 14, by decoupling clasps 56 from catches 54. In the preferred embodiment, the latch 58 is recessed within side 16, 28. In addition to the latches 58, each side 16, 28 of the preferred embodiment comprises one or more tie rings 62,62. These tie rings 62, 62 are pivotally coupled to a recessed tie holder 64. Thus, the container 12 is adapted to be in a closed condition as shown, for example, in FIGS. 1-3 and an open condition as shown, for example, in FIG. 15.

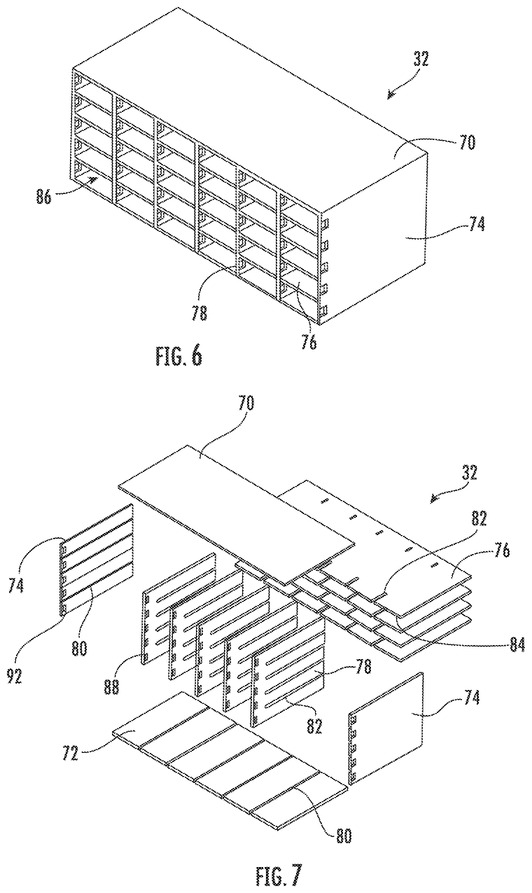

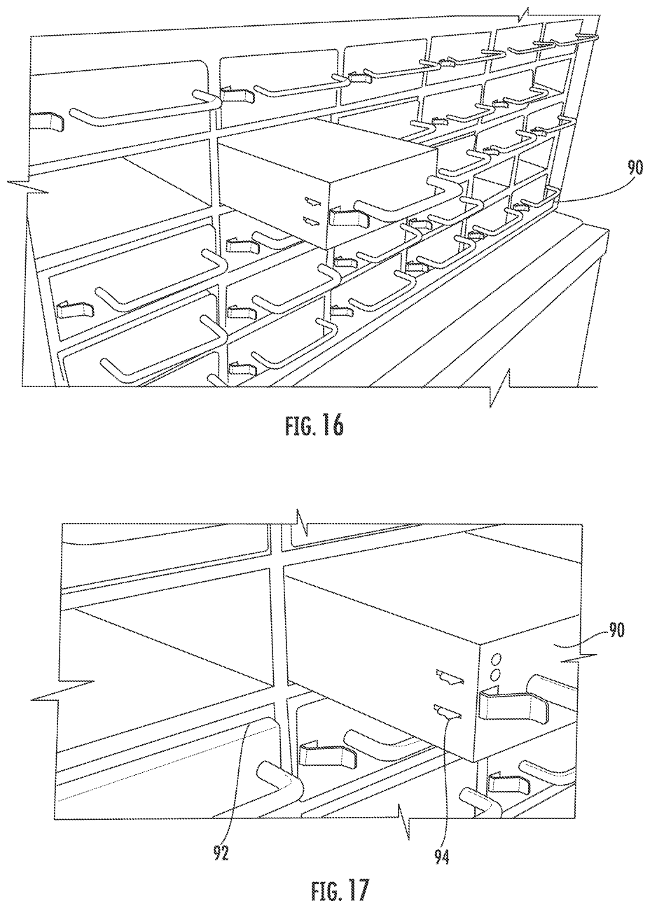

Referring to FIGS. 5 & 6, the respective shuttle assemblies 32, 32 each comprise a shuttle top 70, shuttle bottom 72, shuttle sides 74, shuttle lateral members 76, and shuttle vertical members 78. The shuttle top 70, shuttle bottom 72, and shuttle sides 74 each comprise a plurality of grooves 80 that permit the shuttle assembly 32 to be assembled with close tolerances. Thus, in the preferred embodiment, upper and lower portions of the vertical portions 78 nest within corresponding grooves 80 of the shuttle top 70 and shuttle bottom 72. Similarly, outside edges of the lateral portions 76 nest within corresponding grooves 80 of the shuttle sides 74, 74. The vertical members 78 comprise partial slots 82 adapted to receive the lateral members 76. The lateral members 76 also comprise partial slots 82 which permit front portions 84 of lateral members 76 to be positioned generally flush with front portions 88 of vertical members 78. When assembled, as shown in FIG. 6, a plurality of bays 86 are defined. In the preferred embodiment, each shuttle assembly 32 comprises thirty bays, each bay being adapted to receive a battery backup unit 90 (BBU) (FIGS. 16 & 17). Each of the vertical members 78 and sides 74, 74 further comprise a through opening 78 adapted to receive a movable detent 94 of the battery backup unit 90.

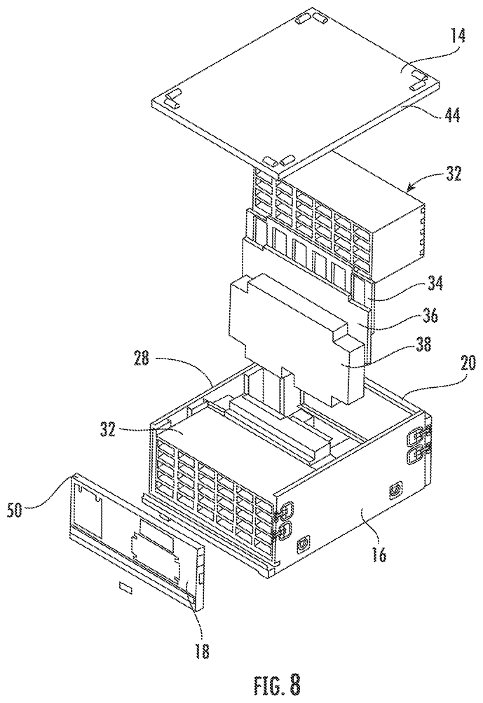

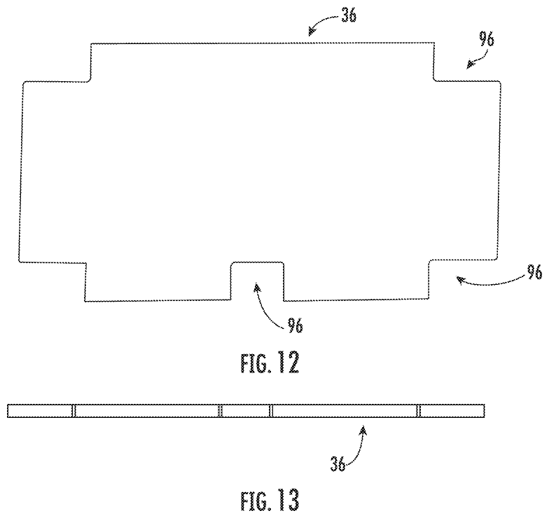

Referring to FIGS. 8-13, when assembled, the container comprises the windowpane dividers 34, 34, the intermediate dividers 36, 36, and the central dividers 38, 38. As depicted in FIG. 11, the windowpane dividers 34, 34 of the preferred embodiment comprise perimeter cutouts 96 that are adapted to permit the windowpane dividers 34, 34 to be positioned adjacent to support members 46 of the top 14 and base 24. The windowpane dividers 34, 34 further comprise central cutouts 98 aligning with the bays 86. With this configuration, portions of the battery backup unit 90 can, for example, extend into the central cutout 98. In the preferred embodiment, the windowpane dividers 34, 34 are formed from closed cell ESD foam. Thus, the windowpane dividers 34, 34 are electrically conductive and is in electrical contact with the aluminum exterior of the container 12 such that static electricity can be discharged.

Referring to FIGS. 12 & 13, the intermediate dividers 36, 36 also comprise perimeter cutouts 96 which are adapted to permit the intermediate dividers 36, 36 to be positioned adjacent to support members 46 of the top 14 and base 24. The intermediate dividers 36, 36 of the preferred embodiment do not comprise central cutouts 98 aligning with the bays 86. Thus, the intermediate dividers 36, 36 serve as a barrier between the respective windowpane dividers 34, 34 and respective central dividers 38, 38. In the preferred embodiment, the intermediate dividers 36, 36 are formed from closed cell ESD foam.

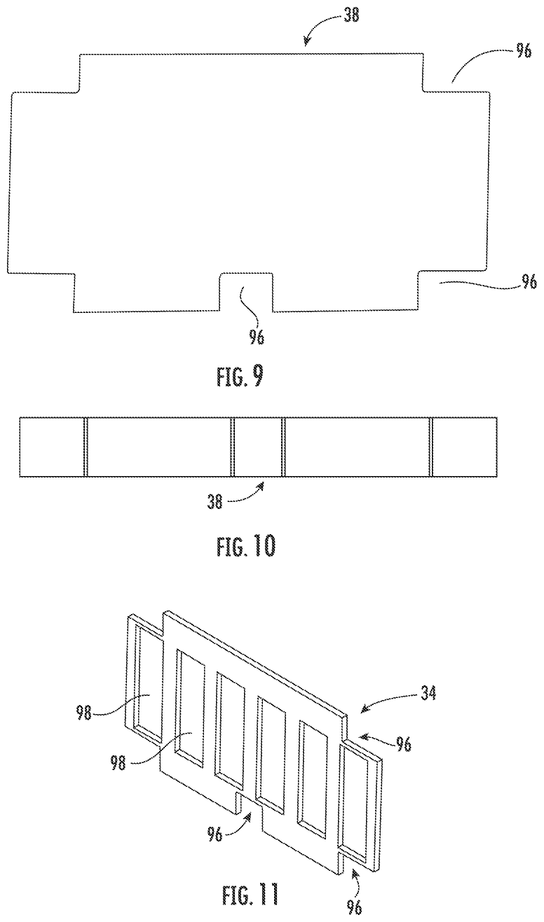

Referring to FIGS. 9 & 10, the central dividers 38, 38 also comprise perimeter cutouts 96 which are adapted to permit the central dividers 38, 38 to be positioned adjacent to support members 46 of the top 14 and base 24. The central dividers 38, 38 of the preferred embodiment do not comprise central cutouts 98 aligning with the bays 86. In the preferred embodiment, the central dividers 38, 38 are formed from closed cell polyethylene that is resilient in nature with favorable recovery characteristics that provide cushioning protection against repeated impacts. The material comprising the central dividers 38, 38 comprises densities ranging from 0.9 pcf density to 9 pcf density in various embodiments. In certain embodiments, the central dividers 38, 38 comprise anti-static and formulations. In some embodiments, the central dividers 38, 38 are electrically conductive and are in electrical contact with the aluminum exterior of the container such that static electricity can be discharged. Referring to FIG. 10, the central dividers 38, 38 are much thicker than the windowpane dividers 34, 34 and the intermediate dividers 36, 36. In preferred embodiments, the vertical dividers 34, 36, 38 comprise fire resistant and/or fire retardant material.

In the preferred embodiment, the shuttle assembly 32 is constructed from HDPE. Exterior portions are constructed from aluminum. The total depth of the container 12 is approximately 54 inches. The total width of the container 12 is approximately 44 inches. The approximate height of the container 12 is approximately 27 inches. In the preferred embodiment, the central dividers 38, 38 are five inches thick while the windowpane dividers 34, 34 and the intermediate dividers 36, 36 measure ¾ inch and one inch, respectively. These dimensions, as other dimensions in this disclosure can vary without departing from the scope and spirit of the invention.

In the preferred embodiment, the battery backup unit storage container 12 is adapted to permit BBU 90 separation for secure transportation. In certain embodiments, the container 12 shuttle assembly 32 is removable and reconfigurable. Thus, the shuttle assembly 32 can comprise, for example, a different number of bays 86. The container 12 has a hinged front 18 and rear 20 for ease of loading/unloading.

In those embodiments, in which the container 12 has a stackable design, this permits containers 12, 13 to be stacked upon one another which optimizes storage space.

In certain embodiments, the container 12 is grounded to reduce risk from electrostatic discharge (ESD).

In the preferred embodiment, the container 12 is formed from aluminum, ESD foam, and HDPE, etc. However, the container 12 may be formed from other suitable materials such as wood. The components of certain embodiments of the container 12 may comprise other natural or man-made suitable materials, such as metals, glass, or materials formed from a variety of polymers, monomers, co-polymers, polyethylene, polypropylene, polyvinyl chloride, polytetrafluoroethylene (PTFE) or other suitable synthetic material, without departing from the scope and spirit of this disclosure.

While there has been illustrated and described what is, at present, considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of this disclosure.

I claim:

1. A battery backup unit container comprising:
a top, front, rear, sides and a base, and a shuttle assembly;
one or more vertical dividers;
the shuttle assembly and one or more vertical dividers being positioned between the top, front, rear, and sides, when the container is in a closed condition;
the shuttle assembly comprising bays, each of the bays being adapted to receive a battery backup unit;
one or more of the top, front, rear, or sides being directly or indirectly hingedly attached to the base such that the container can be selectively placed in the closed condition or an open condition;
at least one of the one or more vertical dividers being electrically conductive;
an exterior of the container being electrically conductive; and
the container being grounded such that static electricity within the container can be discharged.

2. The battery backup unit container of claim 1, wherein at least one of the one or more vertical dividers is positioned between the shuttle assembly and the rear.

3. The battery backup unit container of claim 2, one of the one or more vertical dividers comprising a windowpane divider, the windowpane divider being positioned immediately adjacent to the shuttle assembly and comprising a plurality of through openings aligned with the bays.

4. The battery backup unit container of claim 3, the one or more vertical dividers further comprising an intermediate divider and a central divider, the intermediate divider being positioned between the central divider and the windowpane divider.

5. The battery backup unit container of claim 4, the windowpane divider, the intermediate divider, and the central divider each comprising foam.

6. The battery backup unit container of claim 1, further comprising one or more skids mounted to the base, the skids being structured and arranged to permit the container to be raised with a forked lifting device.

7. The battery backup unit container of claim 1, wherein the front is hingedly moveable such that when the front is in a first position the battery backup unit container is in the closed condition and when in a second position, the battery backup unit container is in the open condition.

8. The battery backup unit container of claim 7, the rear being hingedly moveable.

9. The battery backup unit container of claim 1, the shuttle assembly being formed from HDPE.

10. The battery backup unit container of claim 1, the battery backup unit container being a first battery backup unit container, the first battery backup unit container being stackable such that the first battery backup unit container can be stacked on top of or beneath a second battery backup container.

11. A battery backup unit container comprising:
a top, front, rear, sides and a base, and first and second shuttle assemblies;
one or more vertical dividers;
the shuttle assemblies and one or more vertical dividers being positioned between the top, front, rear, and sides, when the container is in a closed condition;
the shuttle assemblies comprising bays, each of the bays being adapted to receive a battery backup unit;
the front and rear being directly or indirectly hingedly attached to the base such that the container can be selectively placed in the closed condition or an open condition;
at least one of the one or more vertical dividers being electrically conductive;
an exterior of the container being electrically conductive; and
the container being grounded such that static electricity within the container can be discharged.

12. The battery backup unit container of claim 11, wherein at least one of the one or more vertical dividers is positioned between the first shuttle assembly and the second shuttle assembly.

13. The battery backup unit container of claim 12, the one or more vertical dividers comprising first and second windowpane dividers, the first windowpane divider being positioned immediately adjacent to the first shuttle assembly and comprising a plurality of through openings aligned with the first shuttle assembly bays, the second shuttle assembly comprising a plurality of through openings aligned with the second shuttle assembly bays.

14. The battery backup unit container of claim 13, the one or more vertical dividers further comprising first and second intermediate dividers and first and second central dividers, the first intermediate divider being positioned between the first central divider and the first windowpane divider, the second intermediate divider being positioned between the second central divider and the second windowpane divider.

15. The battery backup unit container of claim 14, the windowpane dividers, the intermediate dividers, and the central dividers each comprising foam.

16. The battery backup unit container of claim 11, further comprising one or more skids mounted to the base, the skids being structured and arranged to permit the container to be raised with a forked lifting device.

17. The battery backup unit container of claim 11, wherein the front is hingedly moveable such that when the front is in a first position the battery backup unit container is in the closed condition and when in a second position, the battery backup unit container is in the open condition.

18. The battery backup unit container of claim 17, the rear being hingedly moveable from a first position to a second position.

19. The battery backup unit container of claim 11, battery backup unit container being adapted to prevent thermal runaway.

20. The battery backup unit container of claim 11, the battery backup unit container being a first battery backup unit container, the first battery backup unit container being stackable such that the first battery backup unit container can be stacked on top of or beneath a second battery backup container.
